(19) United States
(12) Patent Application Publication
(10) Pub. No.: US 2020/0239008 A1
(43) Pub. Date: Jul. 30, 2020

(54) LIGHTING DEVICE FOR A LIGHT BEAM WITH A DARKENED CENTRAL REGION

(71) Applicant: Valeo North America, Inc., Troy, MI (US)

(72) Inventors: Benoist FLEURY, Troy, MI (US); Francois LEBLANC, Troy, MI (US); Sophie PORTE, Troy, MI (US)

(73) Assignee: Valeo North America, Inc., Troy, MI (US)

(21) Appl. No.: 16/798,941

(22) PCT Filed: Aug. 2, 2018
(86) PCT No.: PCT/EP2018/071030

§ 371 Date: Feb. 24, 2020

(30) Foreign Application Priority Data
Aug. 31, 2017 (FR) 1758028

(51) Int. Cl. B60W 40/09; G06F 16/25; G06F 16/2457; B60W 50/14; G07C 5/00

(52) U.S. Cl. CPC B60W 40/09; G06F 16/25; G06F 16/24575; B60W 2510/30; G07C 5/008; B60W 2555/20; B60W 2510/18; B60W 50/14

(57) ABSTRACT

A vehicular motion monitoring method comprises capturing motion observations on-board a vehicle with one or more sensors; mapping sets of motion observations onto a respective feature vector in an at least two-dimensional feature space, each feature vector having a first vector component representative of a longitudinal motion characteristic and a second vector component representative of a lateral motion characteristic; updating determinative parameters of a multivariate Gaussian probability density function modelling a population of collected feature vectors; assigning a riskiness indicator to each feature vector, the calculation of the riskiness indicator being based upon an event severity indictor indicative of how anomalous each feature vector is in comparison to the modelled population and upon a position of the feature vector relative to one or more previous and/or subsequent feature vectors; and integrating the riskiness indicator over time so as to obtain a risk assessment of driving style of the driver of the vehicle.

### CROSS REFERENCE TO RELATED APPLICATIONS

This is a 371 application (submitted under 35 U.S.C. § 371) of International Application No. PCT/EP2018/071030 (WO2019042702) filed on Aug. 2, 2018, which claims the priority date benefit of French Application No. FR1758028 filed on Aug. 31, 2017, the dislcosures of which are hereby incorporated by reference in their entirety.

### TECHNICAL FIELD

The present invention relates to the processing of data and in particular data on the driving behaviour of a user of a motor vehicle.

### BACKGROUND

There is a need to evaluate the driving behaviour of users of motor vehicles. To this end, existing applications make provision to use sensors of user mobile terminals (smartphones for example), such as an accelerometer or a GPS module (GPS being the well-known acronym of Global Positioning System), in order to analyse user driving behaviour. Thus, data is acquired by the mobile terminal and uploaded, via an application, to a server of a service provider. The server may be a cloud service platform of the service provider, the service platform being able to bring together data generated by a plurality of motor-vehicle users.

The values (decelerations especially) captured by an accelerometer in particular allow the type of situation referred to as a “near miss”, which is statistically fifteen times more likely than an accident, to be detected, and thus allow analyses to be carried out on a more significant number of samples.

However, the number of sensors in such mobile terminals is restricted and it is thus not possible to correlate the driving behaviour of the user with the context in which the user finds himself (driving during the daytime, driving over wet ground, equipment of the vehicle).

Another solution consists installing a dongle on a diagnostic port of the motor vehicle, which receives information (via a CAN bus) delivered by sensors of the vehicle, which information may thus be sent, via the dongle, to the mobile terminal in order to enrich the data captured by the mobile terminal. As a variant, the data may be uploaded directly by the dongle to a server.

However, not much information is accessible via the diagnostic port. Furthermore, few parameters are generic—most parameters being specific to the motor-vehicle manufacturer. Furthermore, such a solution requires a dongle to be employed in the motor vehicle. This being an expensive solution and requiring access to the diagnostic port, which is complex.

In addition, data accessible via the diagnostic port generally relates to the operation of the motor vehicle: engine speed, engine revs, consumption, indicators of hardware faults, etc.

However as examples, it is not possible to access information relating to wiping, braking or lighting systems, which are not accessible via the CAN bus. Even when such data is accessible, such data is most often encrypted.

The present invention aims to improve the situation.

### SUMMARY

To this end of improving the current situation and state of the art, a first aspect of the invention relates to a method for analysing the driving behaviour of a user of a motor vehicle, comprising the following steps:
acquiring data relating to the driving behaviour of a user, at a time and position, from a mobile terminal of the user;
obtaining contextual data from a database depending on the acquired time and position;
correlating the data relating to driving behaviour and the contextual data.

By expression “data relating to driving behaviour” what is meant is any information acquired while a vehicle is being driven by the user, such as the path of the motor vehicle, its speed, its acceleration, the detection of an accident or near miss, etc.

By expression “to correlate” what is meant is any operation aiming to establish a link between a plurality of types of data, for example by generating a statistically enriched mathematical model. Such operations are well known to those skilled in the art and are not described further in the present description.

By expression “contextual data” what is meant is any datum relating to the driving conditions of the motor vehicle.

The contextual data are therefore obtained by consulting a database based on the time and position of the motor vehicle during the acquisition of the data relating to driving behaviour, thereby allowing to enrich the data without having to add a dongle to the motor vehicle.

According to one embodiment, the analysing method may further comprise acquiring an identifier of the user from the mobile terminal of the user and obtaining, from a database of users, data on the equipment of the motor vehicle of the user depending on the identifier of the user. The data relating to behaviour and the contextual data may further be correlated with the equipment data.

It is thus possible to correlate the impact of the contextual data on driving behaviour with the equipment installed in the motor vehicle and optionally with the wear of this equipment. It thus becomes possible to demonstrate that such a type of equipment degrades less a driving score of a user than another type of equipment. The equipment data is additionally acquired in a way that is transparent to the user.

Alternatively, the method may further comprise acquiring equipment data from the mobile terminal of the user where equipment data may be correlated with the data relating to behaviour and the contextual data.

It is thus possible to correlate the impact of the contextual data on driving behaviour with the equipment installed in the motor vehicle and optionally with the wear of this equipment. It thus becomes possible to demonstrate that such a type of equipment degrades less a driving score of a user than another type of equipment. The user may moreover configure the equipment data, in particular when he modifies the equipment of the motor vehicle.

According to one embodiment, the database may comprise a meteorological database storing time-position pairs indexed with meteorological data, and where obtained contextual data may comprise meteorological data.

Thus, data relating to driving behaviour is correlated with relevant data having a direct influence on the way in which the user drives.

In addition, meteorological data may indicate the presence or absence of rain at the position and time, and equipment information data may indicate a type or model of lighting system, braking system and/or windscreen wipers.

Thus, it is possible to determine the impact of a model or type of equipment on the driving behaviour of a user.

According to one embodiment, the database may comprise an ephemeris database storing time-position pairs indexed with luminosity data, and the obtained contextual data may comprise luminosity data.

Thus, data relating to driving behaviour is correlated with relevant data having a direct influence on the way in which the user drives.

In addition, equipment information data may indicate a type or model of lighting system.

Thus, it is possible to determine the impact of a model or type of lighting system on the driving behaviour of a user.

In addition, the steps of the method may be repeated for each acquisition of data relating to the driving behaviour of a user, at a time and position, and the correlation may comprise statistically estimating the influence of meteorological and luminosity conditions on the driving behaviour of the user.

According to one embodiment, the method may further comprise sending a warning message to the mobile terminal via the server, depending on the correlation between the data relating to driving behaviour and the contextual data.

The user is thus informed in real time of the influence of the contextual data, which may be meteorological, so that he can adapt his driving style, by slowing down or remaining more concentrated for example, this allowing road safety to be improved. The user may further be made aware that a piece of equipment is malfunctioning by means of such a warning message, for example that a lighting system is malfunctioning if the decrease in luminosity is having too great an effect on his driving. The method thus allows the user to be assisted with driving.

A second aspect of the invention relates to a computer-program product comprising code instructions stored on a computer-readable medium, for executing the steps of the method according to the first aspect of the invention.

A third aspect of the invention relates to a server for analysing the driving behaviour of a user of a motor vehicle, comprising:
a first interface configured to acquire data relating to the driving behaviour of a user, at a time and position, from a mobile terminal of the user;
a second interface configured to obtain contextual data from a database depending on the acquired time and position;
a processor configured to correlate the data relating to driving behaviour and the contextual data.

A fourth aspect of the invention relates to a system comprising an analysing server according to the third aspect of the invention and a mobile terminal, said mobile terminal being configured to acquire the data relating to the driving behaviour of the user, the time and position, and to transmit them to the analysing server via a network.

### BRIEF DESCRIPTION OF THE DRAWINGS

Other features and advantages of the invention will become apparent on examining the detailed description that follows, and the appended drawings, in which:

FIG. 1 shows an analysing system according to one embodiment of the invention;

FIG. 2 presents a chart illustrating the steps of an analysing method according to one embodiment of the invention;

FIG. 3 represents a diagram of exchanges between the entities of the analysing system illustrated with reference to FIG. 1;

FIG. 4 illustrates a server according to one embodiment of the invention;

FIG. 5 illustrates a mobile terminal according to one embodiment of the invention.

### DETAILED DESCRIPTION

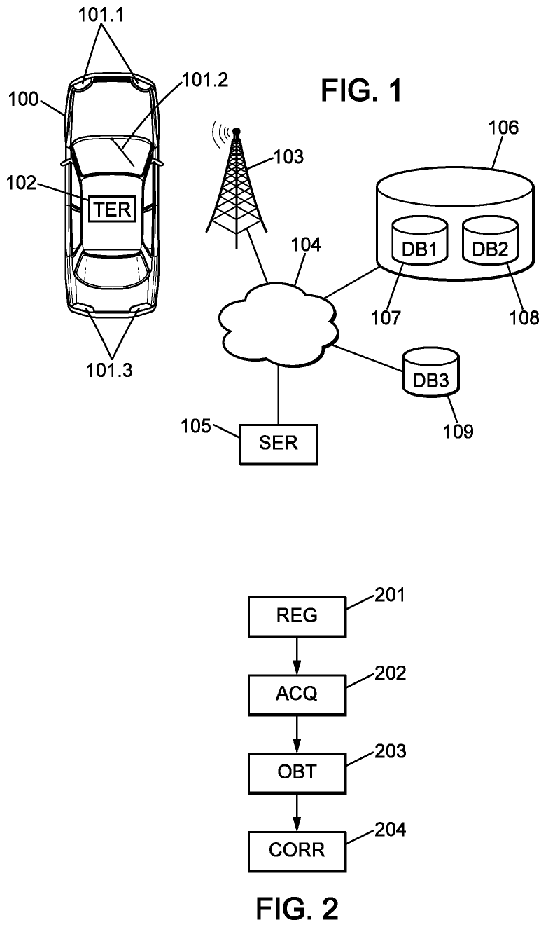

FIG. 1 illustrates a system according to one embodiment of the invention. The system comprises a motor vehicle 100 of a user.

The motor vehicle 100 comprises a set of equipment given by way of illustration, such as a set comprising a lighting system 101.1, windscreen wipers 101.2 and a braking system 101.3.

Each piece of equipment may be of a given type and of a given model. For example, the lighting system may be one of three types: halogen, xenon, LED, etc. A model may identify a manufacturer and a reference number of the manufacturer. As for the model, it may in particular depend on the manufacturer of the piece of equipment, on the year of manufacture or on the name of the model.

When the user is in the motor vehicle, in the process of driving for example, a terminal 102 of the user, called the mobile terminal, is located on-board the motor vehicle. The mobile terminal 102 may for example be a smartphone or any other portable device of the user, such as a laptop or tablet computer. As a variant, the mobile terminal may be an on-board terminal installed in the motor vehicle 100.

The mobile terminal may access a remote server, for example via a mobile network 103 connected to a wide-area Internet communication network 104 for example. No restriction is placed on the mobile network 103, which may be any type of 3G, 4G or later generation data network.

The server 105 is a server of a service provider the objective of which is to analyse the driving behaviour of users, and to correlate such behaviours with contextual information, this allowing the analysis of the driving behaviour of a user to be enriched and in particular contexts leading to accidents or near misses to be determined.

Contrary to prior-art solutions, the system according to the invention comprises a database 106 that is configured to deliver, to the server 105, contextual data depending on time-position pairs uploaded from the mobile terminal 102. There is thus no need to install additional sensors in the motor vehicle, or to connect dongles to diagnostic ports of the motor vehicle.

The database 106 may be a set of databases, in particular comprising a meteorological database 107 and an ephemeris database 108. The meteorological database 107 may store time/position pairs indexed with meteorological data, such as an indication of the presence or absence of rain for example.

An indication of the presence or absence of rain associated with a given time/position pair indicates whether it has rained or not at the given position and at the given time. Such contextual information is relevant in that it makes it possible to determine whether the lighting system 101.1 of the vehicle is activated or not at the given time, whether the windscreen wipers 101.2 are activated or not at the given time, and whether the braking system 101.3 is subjected to a wet or dry road, this allowing the analysis of the driving behaviour of the user to be enriched, in particular in case of an accident or near miss. More generally, such contextual information makes it possible to determine the climatic conditions under which an accident or near miss may occur.

The ephemeris database 108 may store time/position pairs indexed with ephemeris data such as luminosity data indicating an ambient luminosity level. Such contextual information is relevant in that it makes it possible to determine whether the lighting system 101.1 of the vehicle is activated or not at the given time. More generally, such contextual information makes it possible to determine the luminosity conditions under which an accident or near miss may occur.

The server 105 may also access a database of users 109 storing user identifiers indexed with respective equipment data. Such a database in particular makes it possible to determine with what equipment the motor vehicle of the identified user is equipped. No restriction is placed on the way in which the database of users is filled. It may for example be filled with statements made by the user, for example when he creates a user account on the server 105: the user indicates the equipment of the vehicle that he possesses and indicates a user identifier, and this data is stored indexed in the database of users 109 by the server 105. In addition, the user may indicate a state of wear of the equipment of the motor vehicle 100. However, the invention is not restricted to this example alone and the database of users may be filled by any other means. For example, on the basis of the user identifier, the model of the motor vehicle that the user possesses may be accessed, and such a model may be associated by default with given equipment.

No restriction is placed on the service that exploits the obtained analyses of driving behaviour.

The server 105 is preferably accessible by the terminals of a plurality of users, this allowing data generated by a plurality of users to be compiled and thus driver profiles to be enriched.

To this end, an application dedicated to the service provider may be installed on the mobile terminal 102. The application thus allows the server 105 to be accessed directly without having to make use of a web browser, and allows the interface with the user to be improved.

FIG. 2 is a chart illustrating the steps of an analysing method according to one embodiment of the invention.

In an optional step 201, the user, via the mobile terminal 102 or via any other user terminal, registers as a user on the server 105 of the service provider. No restriction is placed on the registering step, which may comprise providing user data, and in particular providing data allowing unique identification of the user. Furthermore, the registering step may comprise defining a password, allowing subsequent authentication of the user of the mobile terminal 102 by the server 105. In addition, as described above, the user may optionally declare the equipment of the motor vehicle, and their respective states of wear.

In a step 202, the server 105 acquires, from the mobile terminal 102 of the user, data relating to the driving behaviour of the user, the data being accompanied by a time and position. The time indicates the moment at which the data relating to driving behaviour were acquired and the position indicates the position of the vehicle during the acquisition of the data relating to driving behaviour.

All the data may be acquired by the mobile terminal 102 with no need to make recourse to additional sensors placed in the motor vehicle 100. Specifically, the data relating to driving behaviour may be speed and/or acceleration data that may be acquired via a GPS by the mobile terminal 102, or via an accelerometer module of the mobile terminal 102. As for the acquisition time, it may be obtained by means of an internal clock of the mobile terminal 102. The position of the mobile terminal 102 may also preferably be determined by GPS, or as a variant depending on the antenna of the mobile network 103 to which the mobile terminal 102 is connected.

As mentioned above, the step 202 may also allow a user identifier to be acquired. The user identifier may be appended to the data relating to driving behaviour, or may be determined by the server 105 in a step in which the mobile terminal 102 connects to the server 105, following an initial registering step.

In a step 203, the server 105 obtains contextual data from the database 106, depending on the acquired time and position. As explained above, the step 203 may also comprise obtaining equipment data from the database of users 109, depending on the identifier of the user.

In a step 204, the data relating to driving behaviour and the contextual data are correlated in order to analyse the driving behaviour of the user.

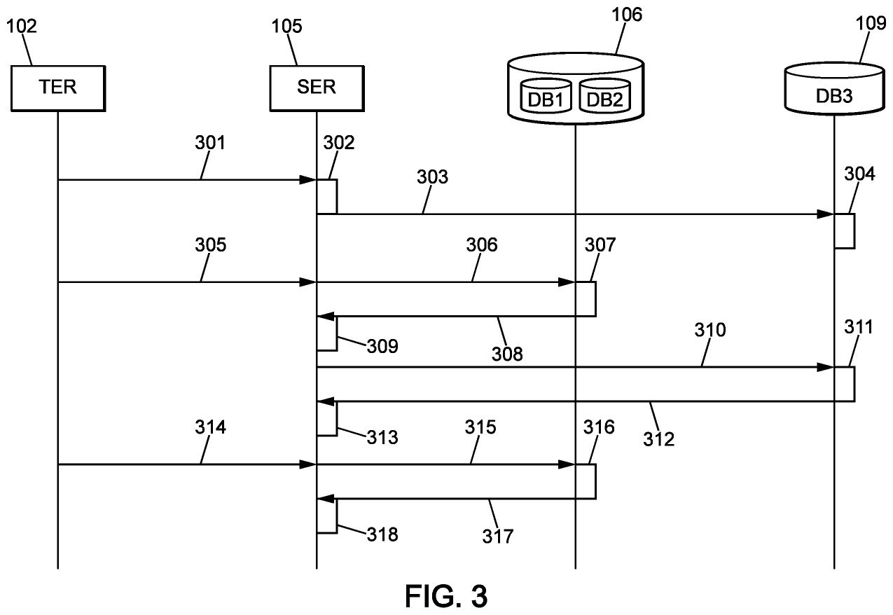

FIG. 3 is a diagram of steps illustrating in a more detailed way the exchanges between certain of the entities of the system presented with reference to FIG. 1.

In an initial and optional step 301, the user of the mobile terminal 102 registers with the server 105, in particular by providing a user identifier and equipment data, or alternatively an identifier of the motor vehicle 100. It will be noted that step 301 is not necessarily implemented between the mobile terminal 102 and the server 105, any user terminal being able to be used by the user instead of the mobile terminal 102.

In a step 302, which is also optional since it is consecutive to step 301, the server 105 may determine, in the case where a motor-vehicle identifier is received in step 301, equipment data depending on the identifier of the motor vehicle. To this end, the server 105 may consult a database (not shown in FIG. 1).

In step 303, the user identifier may be communicated with the equipment data to the database of users 109 in order to be stored therein. In step 304, the database of users 109 stores the equipment data and the user identifier in association.

In a subsequent step 305, the terminal 102 acquires data relating to the driving behaviour of the user, and transmits them to the server 105 with the time and position that correspond to the acquisition. In addition, and optionally, the server 105 furthermore transmits a user identifier, if it has not been transmitted beforehand.

In a step 306, the server 105 consults the database in order to obtain contextual data corresponding to the time and position acquired in step 305. To this end, a request identifying the time and position may be sent to the database 106. In step 307, the database 106 determines the contextual data corresponding to the time and position indicated in the request. The database 106 returns the determined contextual data, in step 308, to the server 105.

The server 105 then correlates, in a step 309, the received contextual data and the data relating to the driving behaviour of the user. By “to correlate”, what is meant is any operation aiming to establish a link between a plurality of types of data, for example by generating a statistically enriched mathematical model. Such operations are well known to those skilled in the art and are not described further in the present description.

Such a correlation may then be used to adjust a driving score of the driver. Furthermore, by repeating the steps of the method on the same routes or on statistically similar routes, it is possible to generate a model that describes the impact of meteorological conditions on the driving score. No restriction is placed on the use made of the correlation obtained by the analysing method according to the invention. For example, when a driving score of the driver becomes too low, lower than a given threshold for example, a warning may be sent to the driver. Alternatively, when it is determined that the context is having a large effect on the driving behaviour of the user, a warning message may be sent by the server 105 to the terminal 102, in order to inform the user thereof and encourage him to be more careful. The method according to invention thus allows the safety of the user to be improved while avoiding direct measurement of contextual data in the vehicle: these data are deduced from the time and position of the motor vehicle 100.

As mentioned above, in a step 310, the server 105 may furthermore transmit the user identifier to the database of users 109. Such a step is optional as mentioned above. In a step 311, the database of users 109 deduces, from the received user identifier, data on the equipment of the motor vehicle 100 of the identified user.

The equipment data are returned in step 312 to the server 105.

In a step 313, the server 105 may then correlate the equipment data with the received contextual data and the data relating to the driving behaviour of the user. The present invention thus allows the impact of vehicle equipment on the driving behaviour of the user to be evaluated. It is thus possible to deduce vehicle equipment that improves the driving of the user. This is in addition achieved without requiring a direct measurement of the operating state of the vehicle equipment of the motor vehicle 102, since the contextual data are known.

Thus, the present invention has the following advantages:
evaluation of the impact of contextual data, such as meteorological conditions and/or natural luminosity conditions, on the driving of users,
furthermore, correlation of such an impact with the equipment installed on the motor vehicle and optionally with the wear of the equipment. It thus becomes possible to demonstrate that such a type of equipment degrades the driving score of a user less than another type of equipment;
avoidance of any physical installation of additional hardware in motor vehicles. The mobile terminal 102 may in particular already comprise geo-position, speed and acceleration sensors. The deployment of the method according to the invention is thus facilitated.

The step of acquiring data on the driving behaviour of the user (step 305) may be repeated in step 314, for a new time/position pair of the motor vehicle. Steps 315 to 317, which are similar to steps 306 to 308, may then be carried out, according to the method, on the basis of the new time/position pair of the motor vehicle. Thus, the driving-behaviour data may be regularly updated, for example with a fixed time step, for example equal to one second.

In step 318, the new driving-behaviour data may be correlated with the contextual data obtained using the new time/position pair of the motor vehicle 100, while enriching for example a statistical model.

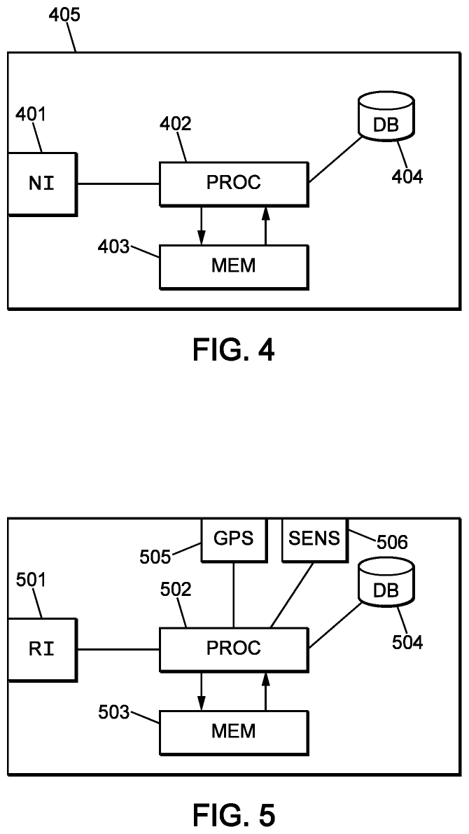

FIG. 4 shows the server 105 according to one embodiment of the invention.

The server 105 comprises a random access memory 403 and a processor 402 for storing instructions allowing steps 301, 302, 303, 305, 306, 308, 309, 310, 312, 313, 314, 315, 317 and step 318 to be carried out. The server 105 may comprise a database 404 for storing data intended to be preserved before, during or after the application of the method. The database 404 may in particular incorporate all or some of the database 106 and/or of the database of users 109. The server furthermore comprises a network interface 401 configured both to communicate with the databases 106 and 109, in the case where they are not included in the database 404, and with the mobile terminal 102, via the network 104. Generally, the network interface 401 allows interaction with any entity connected to the wide-area network 104. A single network interface 501 has been shown. However the invention may make provision for the server 105 to comprise a second interface for communicating with the database 106 and/or the database 109.

FIG. 5 shows a mobile terminal 102 according to one embodiment of the invention.

The mobile terminal 102 comprises a random-access memory 503 and a processor 502 for storing instructions allowing steps 301, 305 and 314 to be carried out. Furthermore, the processor may execute an application dedicated to the service provided by the service provider corresponding to the server 105. The mobile terminal 102 may comprise a database 504 for storing data intended to be preserved before, during or after the application of the method. For example, the database 504 may store a user identifier, equipment data, driving-behaviour data and may store the code of the application dedicated to the server 105.

The mobile terminal 102 may comprise one or more sensors 506, such as an accelerometer for example, and a GPS module 505.

Furthermore, the mobile terminal 501 comprises an interface 501, such as a radio interface, allowing the mobile network 103, the wide-area network 104 and therefore the server 105 to be accessed.

Of course, the invention is not limited to the embodiments described above, which were given merely by way of example. It encompasses various modifications, alternative forms and other variants that those skilled in the art will be able to envision, in the context of the present invention, and in particular any combination of the various embodiments described above.

1. A method for analyzing the driving behavior of a user of a motor vehicle, comprising the following steps:
acquiring data relating to the driving behavior of a user, at a time and position, from a mobile terminal of the user;
obtaining contextual data from a database depending on the acquired time and position;
correlating the data relating to driving behavior and the contextual data.

2. The method according to claim 1, further comprising acquiring an identifier of the user from the mobile terminal of the user and obtaining, from a database of users, data on the equipment of the motor vehicle of the user depending on the identifier of the user;
and wherein the data relating to behavior and the contextual data are furthermore correlated with equipment information data.

3. The method according to claim 1, further comprising acquiring equipment information data from the mobile terminal of the user,
and wherein the equipment information data are correlated with the data relating to behavior and the contextual data.

4. The method according to claim 1, wherein the database comprises a meteorological database storing time-position pairs indexed with meteorological data, and wherein the obtained contextual data comprise meteorological data.

5. The method according to claim 4, wherein the meteorological data indicate the presence or absence of rain at said position and at said time, and wherein the equipment information data indicate a type or model of lighting system, of braking system or of windscreen wipers.

6. The method according to claim 1, wherein the database comprises an ephemeris database storing time-position pairs indexed with luminosity data, and wherein the obtained contextual data comprises luminosity data.

7. The method according to claim 2, wherein the equipment information data indicate a type or model of lighting system.

8. The method according to claim 1, wherein the steps of the method are repeated for each acquisition of data relating to the driving behavior of a user, at a time and position, and wherein the correlation comprises statistically estimating the influence of meteorological and luminosity conditions on the driving behavior of the user.

9. The method according to claim 1 further comprising sending a warning message to the mobile terminal via the server, depending on the correlation between the data relating to driving behavior and the contextual data.

10. A computer-program product comprising code instructions stored on a computer-readable medium, for executing the steps of the method as claimed in claim 1.

11. A server for analyzing the driving behavior of a user of a motor vehicle, comprising:
a first interface configured to acquire data relating to the driving behavior of a user, at a time and position, from a mobile terminal of the user;
a second interface configured to obtain contextual data from a database depending on the acquired time and position;
a processor configured to correlate the data relating to driving behavior and the contextual data.

12. A system comprising an analysing server according to claim 11 and a mobile terminal said mobile terminal being configured to acquire the data relating to the driving behavior of the user, the time and position, and to transmit them to the analyzing server via a network.

13. The method according to claim 3, wherein the equipment information data indicate a type or model of lighting system.
